(19) United States
(12) Patent Application Publication
(10) Pub. No.: US 2026/0112243 A1
(43) Pub. Date: Apr. 23, 2026

(54) SYSTEMS AND METHODS FOR IDENTIFYING REAL-TIME NETWORK DATA STRUCTURE ASSOCIATIONS USING LANGUAGE MODELS

(71) Applicant: DK Crown Holdings Inc., Boston, MA (US)

(72) Inventors: Robin Mohseni, Billericay (GB); Gengyuan Zhang, Boston, MA (US)

(73) Assignee: DK Crown Holdings Inc., Boston, MA (US)

(21) Appl. No.: 19/360,880

(22) Filed: Oct. 16, 2025

Related U.S. Application Data
(60) Provisional application No. 63/708,504, filed on Oct. 17, 2024.
(60) Provisional application No. 63/708,528, filed on Oct. 17, 2024.
(60) Provisional application No. 63/708,509, filed on Oct. 17, 2024.
(60) Provisional application No. 63/708,492, filed on Oct. 17, 2024.
(60) Provisional application No. 63/708,554, filed on Oct. 17, 2024.
(60) Provisional application No. 63/708,542, filed on Oct. 17, 2024.
(60) Provisional application No. 63/711,415, filed on Oct. 24, 2024.
(60) Provisional application No. 63/719,406, filed on Nov. 12, 2024.
(60) Provisional application No. 63/741,297, filed on Jan. 2, 2025.
(60) Provisional application No. 63/741,671, filed on Jan. 3, 2025.

(51) Int. Cl. G07F 17/32; G06F 40/40; G06Q 50/34

(52) U.S. Cl. CPC G07F 17/323; G06F 40/40; G06Q 50/34; G07F 17/3237; G07F 17/3288

(57) ABSTRACT

Systems and methods for identifying real-time network data structure associations using language models are disclosed. A system can maintain wager opportunities corresponding to a plurality of live events. The wager opportunities can identify at least one of a plurality of teams or a plurality of participants of one or more live events. The system can maintain a dataset identifying participant attributes and team attributes. The system can receive, from a client device, a prompt requesting a wager recommendation. The request can identify a requested attribute of a participant or a team. The system can generate, using a language model, the prompt, and at least a portion of the dataset, an output message identifying at least one wager opportunity of the plurality of wager opportunities selected based on the requested attribute. The system can provide the output message to the client device in response to the request.

### CROSS-REFERENCES TO RELATED APPLICATIONS

This application claims the benefit of and priority to U.S. Provisional Ser. No. 63/741,297 , filed Jan. 2, 2025; and claims the benefit of and priority to U.S. Provisional Ser. No. 63/708,509 , filed Oct. 17, 2024; and claims the benefit of and priority to U.S. Provisional Ser. No. 63/708,492 , filed Oct. 17, 2024; and claims the benefit of and priority to U.S. Provisional Ser. No. 63/708,528 , filed Oct. 17, 2024; and claims the benefit of and priority to U.S. Provisional Ser. No. 63/708,542, filed Oct. 17, 2024; and claims the benefit of and priority to U.S. Provisional Ser. No. 63/708,504 , filed Oct. 17, 2024; and claims the benefit of and priority to U.S. Provisional Ser. No. 63/711,415 , filed Oct. 24, 2024; and claims the benefit of and priority to U.S. Provisional Ser. No. 63/708,554 , filed Oct. 17, 2024; and claims the benefit of and priority to U.S. Provisional Ser. No. 63/719,406 , filed Nov. 12, 2024; and claims the benefit of and priority to U.S. Provisional Ser. No. 63/741,671, filed Jan. 3, 2025; the contents of each of which are incorporated herein by reference in their entireties for all purposes.

### BACKGROUND

Network environments can support communication between multiple computing devices using techniques such as packet-switching. Data transmitted between devices can be synchronized such that multiple devices on the same network access the same information. However, it can be challenging to efficiently synchronize data transmission for graphical elements using conventional networking technology.

### SUMMARY

The systems and methods described herein provide techniques for improving wager placement processes by utilizing language models in combination with stored data to generate wagering recommendations. The wager recommendations can be personalized to each player. In particular, the systems and methods can maintain datasets related to teams and participants, including teams and participants attributes, and leverage the data to interpret player prompts that describe teams and participants attributes (e.g., characteristics). The language model can identify associations based on participant prompts and generate wager opportunities that align with participant preferences. This approach allows for dynamic interactions with players, offering wager recommendations that reflect both historical and contextual information about teams and participants. The systems and methods can provide iterative prompts to refine the player request, allowing for enhanced customization and accuracy in wager recommendations. The systems and methods can simplify the wager selection process by automating complex queries and delivering personalized results based on user input. The systems and methods described herein therefore provide a technical improvement over conventional wager recommendation systems that rely on static, pre-determined lists or manual selection processes.

At least one other aspect of the present disclosure is directed to a system. The system can maintain a plurality of wager opportunities corresponding to a plurality of live events. Each of the plurality of wager opportunities can identify at least one of a plurality of teams or a plurality of participants of one or more live events. The system can maintain a dataset identifying one or more participant attributes of the plurality of participants and one or more team attributes of the plurality of teams. The system can receive, from a client device, a prompt comprising a request for a wager recommendation, the request identifying a requested attribute of a participant of the plurality of participants or a team of the plurality of teams. The system can generate, using a language model, the prompt, and at least a portion of the dataset, an output message that can identify at least one wager opportunity of the plurality of wager opportunities selected based on the requested attribute. The system can provide the output message to the client device in response to the request.

In some implementations, the one or more team attributes can include one or more of a ranking of each of the plurality of teams, a performance of a corresponding team of the plurality of teams in one or more live events, or a type of sport in which each of the plurality of teams participate. The one or more participant attributes can include one or more of a ranking of each of the plurality of participants or subsets thereof, one or more performance metrics of each of the plurality of participants in one or more live events, or one or more associations with the plurality of teams. The system can determine that the request includes an attribute request for wager opportunities corresponding to one or more top ranking players. The system can select a subset of the plurality of wager opportunities that identify one or more participants of the plurality of participants that satisfy the attribute request.

In some implementations, the system can generate an input context for the language model to include data of the subset of wager opportunities. The system can generate the output message by providing the input context to the language model. The system can generate the output message to include a plurality of candidate wager opportunities selected from the plurality of wager opportunities. Each candidate wager opportunity can be selected based on a similarity between the candidate wager opportunity and the at least one requested attribute. The system can receive, from the client device, a second prompt identifying a second requested attribute. The system can generate, using the language model and the second prompt, a second output message that can include a first wager opportunity of the plurality of candidate wager opportunities. The first wager opportunity can be selected based on the second requested attribute.

In some implementations, the dataset can include one or more historical participant attributes of one or more historical participants or one or more historical team attributes of one or more historical teams. The system can receive, from a client device, a second prompt that includes a second request for a wager recommendation. The second request can identify a historical attribute of the plurality of historical participants that can relate to one or more of the plurality of participants. The system can generate, using the language model, the second prompt, and data of the plurality of wager opportunities, an output message identifying at least one second wager opportunity of the plurality of wager opportunities selected based on the historical attribute. The client device can be associated with a player profile. The system can generate the output message further based on the player profile.

At least one aspect of the present disclosure relates to a method. The method can be performed, for example, by one or more processors coupled to a non-transitory memory. The method can include maintaining a plurality of wager opportunities corresponding to a plurality of live events. Each of the plurality of wager opportunities can identify at least one of a plurality of teams or a plurality of participants of one or more live events. The method can include maintaining a dataset identifying one or more participant attributes of the plurality of participants and one or more team attributes of the plurality of teams. The method can include receiving from a client device, a prompt comprising a request for a wager recommendation. The request can identify a requested attribute of a participant of the plurality of participants or a team of the plurality of teams. The method can include generating, using a language model, the prompt, and at least a portion of the dataset, an output message identifying at least one wager opportunity of the plurality of wager opportunities selected based on the requested attribute. The method can include providing the output message to the client device in response to the request.

In some implementations, the one or more team attributes can include one or more of a ranking of each of the plurality of teams, a performance of a corresponding team of the plurality of teams in one or more live events, or a type of sport in which each of the plurality of teams participate. The one or more participant attributes can include one or more of a ranking of each of the plurality of participants or subsets thereof, one or more performance metrics of each of the plurality of participants in one or more live events, or one or more associations with the plurality of teams. The method can include determining that the request includes an attribute request for wager opportunities corresponding to one or more top ranking players. The method can include selecting a subset of the plurality of wager opportunities that identify one or more participants of the plurality of participants that satisfy the attribute request.

In some implementations, the method can include generating an input context for the language model to include data of the subset of wager opportunities. The method can include generating the output message by providing the input context to the language model. The method can include generating the output message to include a plurality of candidate wager opportunities selected from the plurality of wager opportunities. Each candidate wager opportunity can be selected based on a similarity between the candidate wager opportunity and the at least one requested attribute. The method can include receiving, from the client device, a second prompt identifying a second requested attribute. The method can include generating, using the language model and the second prompt, a second output message comprising a first wager opportunity of the plurality of candidate wager opportunities. The first wager opportunity can be selected based on the second requested attribute.

In some implementations, the dataset can include one or more historical participant attributes of one or more historical participants or one or more historical team attributes of one or more historical teams. The method can include receiving, from a client device, a second prompt including a second request for a wager recommendation. The second request can identify a historical attribute of the plurality of historical participants that relates to one or more of the plurality of participants. The method can include generating, using the language model, the second prompt, and data of the plurality of wager opportunities, an output message identifying at least one second wager opportunity of the plurality of wager opportunities selected based on the historical attribute. The client device can be associated with a player profile. The method can include generating the output message further based on the player profile.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of an example system for identifying real-time network data structure associations using language models, in accordance with one or more implementations;

FIGS. 2A and 2B illustrate example user interfaces of a communication session on a client device, in accordance with one or more implementations; and

FIG. 3 illustrates an example flow diagram of a method of identifying data structure associations using language model, in accordance with one or more implementations; and

FIG. 4 illustrates a block diagram of a server system and a client computer system in accordance with an illustrative implementation.

### DETAILED DESCRIPTION

Below are detailed descriptions of various concepts related to, and implementations of, techniques, approaches, methods, apparatuses, and systems for parameter search and adjustment. The various concepts introduced above and discussed in greater detail below may be implemented in numerous ways, as the described concepts are not limited to any particular manner of implementation. Examples of specific implementations and applications are provided primarily for illustrative purposes.

Natural language processing techniques can be applied across a wide range of computing environments to generate responses or other outputs based on natural language prompts. Language models and other machine-learning models can be used in various applications, including but not limited real-time information retrieval interfaces, which can be limited according to processing capacity of the systems executing such machine-learning models. To perform such operations, a language model can process input data sequences that represent prompts, contextual information, and other relevant data.

As language models typically include a large number of parameters, invoking such language models typically requires significant processing resources that make language models challenging to use for certain applications (e.g., real-time or near real-time applications. The number of operations and the amount of memory used to process a prompt is generally influenced by the size of the input context provided to the language model. Input contexts can include historical exchanges, metadata, and/or external reference information that may be relevant to generating an accurate or contextually suitable output. Generating suitable outputs typically involves providing large amounts of information as input to language models, which can significantly hinder performance, both in terms of accuracy and execution performance (e.g., computing resource utilization).

Conventional techniques for supplying input contexts to language models fail to ameliorate these issues. For example, conventional approaches often require sending large contexts, which often include an entire accumulated input, across multiple requests to achieve a requested output. Increasing the size of the input context results in increased network latency and bandwidth consumption. During output generation, executing language models with large input contexts causes processor load and increased memory allocation that grow at rates that reduce the feasibility of using language model in many real-time or near real-time applications. As a result, existing systems experience limited throughput, excessive memory consumption, and elevated network resource usage.

The techniques described herein address these and other issues by generating targeted input contexts for a language model that include only data determined to be relevant to a given prompt. In general, the techniques can select prompt-specific subsets of available context data based on one or more classification processes and/or rule-based policies. By constructing an input context from only the selected subset, the techniques described herein can significantly reduce the processing resources needed to process the input context without omitting information that is pertinent to generating an accurate output. Such context selection operations can be perform in connection with session-based data persistence, such that follow-on prompts can be processed according to previously stored interaction data, in some implementations.

By selectively reducing the contents of an input context based on prompt relevance and by avoiding redundant transmission of static context data, the techniques described herein can lower processing time and memory requirements for language model execution. Network bandwidth consumption can also be reduced because only incremental or newly relevant data is transmitted for follow-on prompts, rather than the entire accumulated context. These improvements can provide faster response times for multi-turn interactions, sustain throughput in high-load scenarios, and enable the use of large-scale language models within low-latency applications where conventional approaches would exceed performance constraints.

In further detail, various implementations of the systems and methods described herein can be used to reduce processor utilization and memory consumption when processing prompts with additional contextual input via one or more language models or other machine-learning models. For example, a system can maintain one or more data structures storing specific information that can be automatically selected for inclusion in an input context of the language/machine-learning models. As noted above, the computing resources (e.g., computing time and/or memory/caching consumption) used to execute language models or other natural language processing functions on computers increase at least quadratically with the size of the input context (e.g., the input data to be processed). Executing language models using existing techniques therefore restricts the context size according to the expected/target processing time of a corresponding request. For real-time or near real-time applications, such extended delays make using language models impossible to use.

To address these challenges, the systems and methods described herein can dynamically generate an input context that includes a subset of data that can be used to carry out requested computing operations. Such automatic selection may be performed, for example, according to intent classification operations executed using additional machine-learning models and/or specific rules-based selection policies. By automatically selecting certain data to be included in the input context, the systems and methods described herein automatically limit the input context for the language model to a targeted subset of available data, thereby reducing the latency (e.g., processing time) and memory allocation required to carry out the requested operations using the language model. As a result, the systems and methods described herein operate more efficiently, and allow for the use of language models in real-time or near real-time processing applications, which would otherwise be impossible to implement using existing techniques.

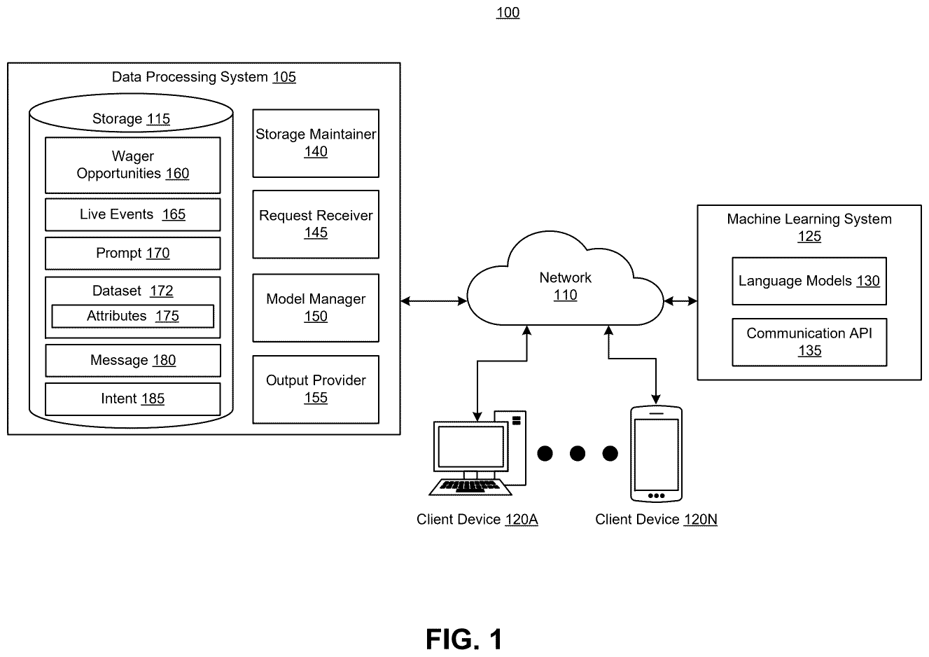

Referring now to FIG. 1, illustrated is a block diagram of an example system 100 for identifying real-time network data structure associations using language models, in accordance with one or more implementations. The system 100 can include at least one data processing system 105, one or more client devices 120A-120N (sometimes generally referred to in the singular or the plural as “client device(s) 120”) and a machine learning system 125. The data processing system 105 can be a server system, a cloud-computing platform, a local computing system, a node in a distributed network, a desktop computer, a client device, or any other system that can process information. The data processing system 105 can be or include one or multiple computing nodes, servers, or distributed processing systems. The data processing system 105 can include a storage maintainer 140, a request receiver 145, an model manager 150, an output provider 155, and at least one storage 115. The storage 115 can include one or more wager opportunities 160, live events 165, prompts 170, datasets 172, attributes 175 or messages 180.

Although shown here as internal to the data processing system 105, the storage 115 can be external to the data processing system 105, for example, as a part of a cloud computing system or an external computing device in communication with the devices (e.g., the data processing system 105, the client device 120, etc.) of the system 100 via the network 110.

Each of the components (e.g., the storage maintainer 140, the request receiver 145, the model manager 150, the output provider 155, and the storage 115, etc.) of the system 100 can be implemented using the hardware components or a combination of software with the hardware components of a computing system, such as any other computing system described herein. Each of the components (e.g., the storage maintainer 140, the request receiver 145, the model manager 150, the output provider 155, and the storage 115, etc.) can be implemented on a single data processing system 105 or implemented on multiple, separate data processing systems 105. Although various processes are described herein as being performed by the data processing system 105, it should be understood that said operations or techniques may also be performed by other computing devices (e.g., one or more client devices 120, models of the machine learning system 125, etc.), either individually or via communications with the data processing system 105. Each of the components of the data processing system 105 can perform the functionalities detailed herein.

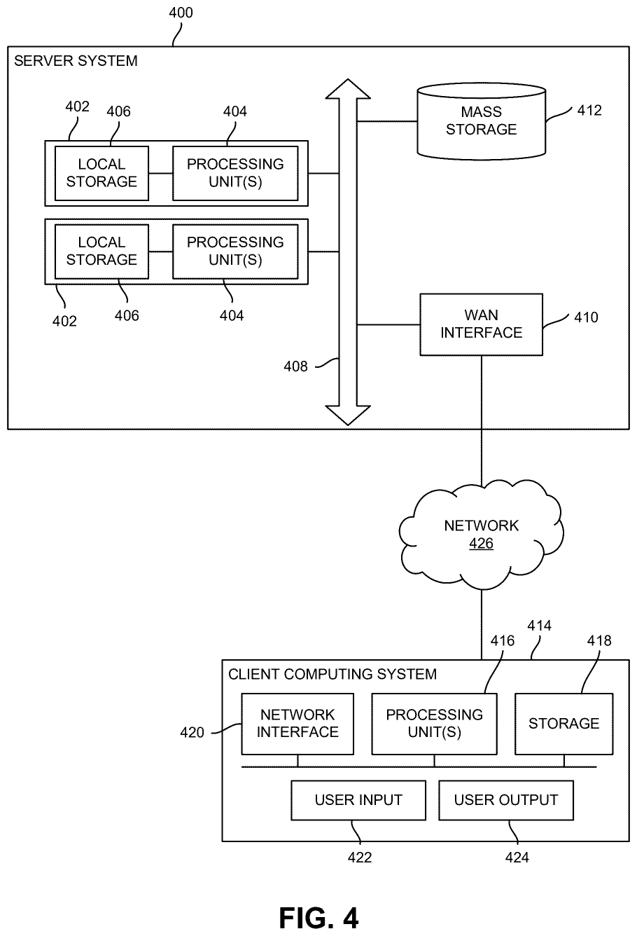

The data processing system 105 can include at least one processor and a memory (e.g., a processing circuit). The memory can store processor-executable instructions that, when executed by a processor, cause the processor to perform one or more of the operations described herein. The processor may include a microprocessor, an application-specific integrated circuit (ASIC), a field-programmable gate array (FPGA), a graphics processing unit (GPU), a tensor processing unit (TPU), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data processing system 105 can include one or more computing devices or servers that can perform various functions as described herein. The data processing system 105 can include any or all the components and perform any or all the functions of the computer system 400 described in connection with FIG. 4.

In some implementations, the data processing system 105 may communicate with the client device 120, for example, to receive, transmit, or process data, via the network 110. In one example, the data processing system 105 can be or can include an application server or webserver, which may include software modules allowing various computing devices (e.g., the client device 120, etc.) to access or manipulate data stored by the data processing system 105.

The network 110 can include computer networks such as the Internet, local, wide, metro or other area networks, intranets, satellite networks, other computer networks, such as mobile phone (voice or data) communication networks, or combinations thereof. The data processing system 105 of the system 100 can communicate via the network 110 with one or more computing devices, such as the one or more client devices 120. The network 110 may be any form of computer network that can relay information between the data processing system 105, the one or more client devices 120, the machine learning system 125, and one or more information sources, such as web servers or external databases, amongst others. In some implementations, the network 110 may include the Internet and/or other types of data networks, such as a local area network (LAN), a wide area network (WAN), a cellular network, a satellite network, or other types of data networks. The network 110 may also include any number of computing devices (e.g., computers, servers, routers, network switches, etc.) that are configured to receive or transmit data within the network 110.

The network 110 may further include any number of hardwired or wireless connections. Any or all of the computing devices described herein (e.g., the data processing system 105, the one or more client devices 120, the computer system 100, etc.) may communicate wirelessly (e.g., via Wi-Fi, cellular communication, radio, etc.) with a transceiver that is hardwired (e.g., via a fiber optic cable, a CAT5 cable, etc.) to other computing devices in the network 110. Any or all of the computing devices described herein (e.g., the data processing system 105, the one or more client devices 120, the computer system 100, etc.) may also communicate wirelessly with the computing devices of the network 110 via a proxy device (e.g., a router, network switch, or gateway).

The client device 120 can include at least one processor and a memory (e.g., a processing circuit). The memory can store processor-executable instructions that, when executed by the processor, cause the processor to perform one or more of the operations described herein. The processor can include a microprocessor, an ASIC, an FPGA, a GPU, a TPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client device 120 can include at least one computing device or server that can perform various operations as described herein.

Each client device 120 can be a personal computer, a laptop computer, a television device, a smart phone device, a mobile device, or another type of computing device. Each client device 120 can be implemented using hardware or a combination of software and hardware. Each client device 120 can include a display or display portion. The display can include a display portion of a television, a display portion of a computing device, or another type of interactive display (e.g., a touchscreen, etc.). Each client device 120 may include one or more I/O devices (e.g., a mouse, a keyboard, digital keypad, buttons, trackpads, touch sensor of the touchscreen, etc.). The display can include a touch screen displaying an application, such as a web browser application or a native application, which may be used to access the functionality of the data processing system 105, as described herein.

A client device 120 can receive interactions from a user (sometimes referred to herein as a “player”). The client device 120 may also receive interactions via any other type of I/O device. The interactions can result in interaction data, which can be stored and transmitted by the processing circuitry of the client device 120. The interaction data can include, for example, interaction coordinates, an interaction type (e.g., drag, click, swipe, scroll, tap, etc.), and an indication of an actionable object (e.g., an interactive user-interface element, such as a button, hyperlink, etc.) with which the interaction occurred. The interaction data can identify a user-interface element with which the interaction occurred.

The client device 120 can be a smartphone device, a mobile device, a personal computer, a laptop computer, a television device, a broadcast receiver device (e.g., a set-top box, a cable box, a satellite receiver box, etc.), or another type of computing device. The client device 120 can be implemented hardware or a combination of software and hardware. The client device 120 can include a display or display portion. The display can include a touchscreen display, a display portion of a television, a display portion of a computing device, a monitor, a GUI, or another type of interactive display (e.g., a touchscreen, a graphical interface, etc.) and one or more I/O devices (e.g., a touchscreen, a mouse, a keyboard, digital key pad). The client device 120 can include or be identified by a device identifier, which can be specific to each respective client device 120. The device identifier can include a script, code, label, or marker that identifies a particular client device 120. In some implementations, the device identifier can include a string or plurality of numbers, letters, characters, or any combination numbers, letters, and characters. In some embodiments, each client device 120 can have a unique device identifier.

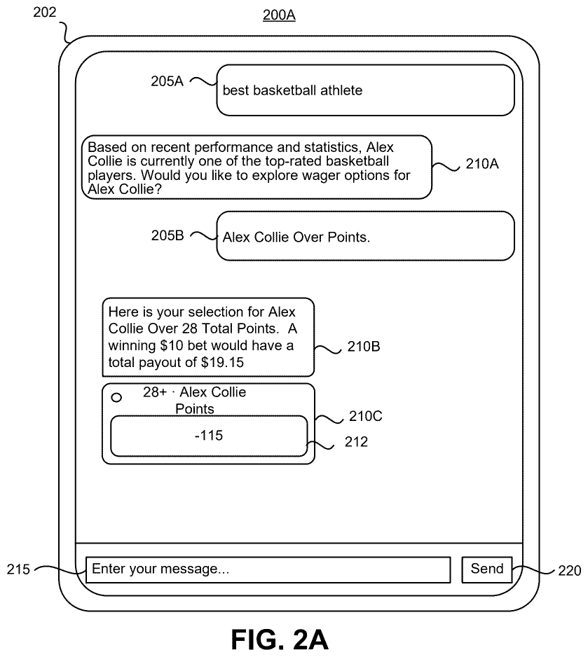

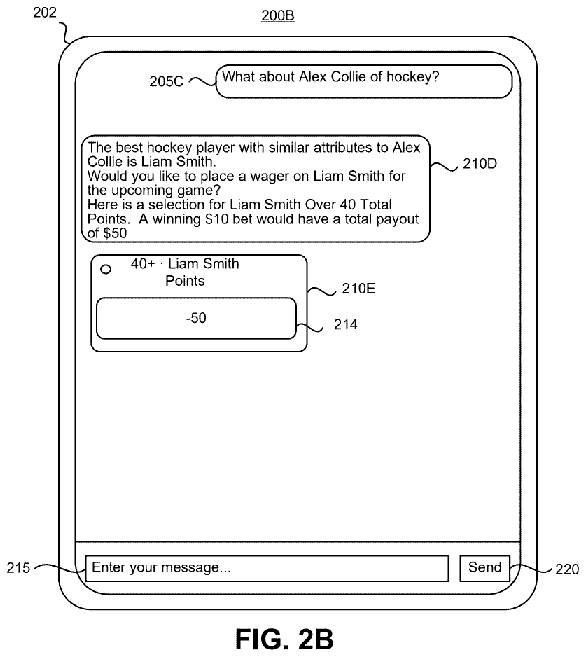

Each client device 120 can include a client application. The client application can be or include a web browser or a local application that communicates with the data processing system 105. The client application can include and/or present graphical user interfaces (e.g., the user interfaces described in connection with FIGS. 2A-2B, etc.). The graphical user interfaces may be referred to as application interfaces. The client application can initiate and/or terminate communication sessions. The client application can input prompts 170 into one or more communication sessions and generate one or more data records. The client application can display a history of prompts 170 and messages 180 within one or more communication sessions. The client application can include a web application, a server application, a resource, a desktop, or a file. Other functionalities described herein may also be provided by the client application.

The client application can include a local application (e.g., local to a client device 120), hosted application, a SaaS application, a virtual application, a mobile application, or other forms of content. In some implementations, the client application can include or correspond to applications provided by remote servers or third-party servers. The application may generate or otherwise present one or more graphical user interfaces (e.g., interactive user-interface elements). The graphical user interfaces can include user-selectable hyperlinks, buttons, graphics, videos, images, or other interactive elements to control the functionality of the application make corresponding requests to the data processing system 105 to perform any of the techniques described herein. Interactions with such interactive user-interface elements (sometimes referred to as “actionable objects”) can cause the client application executing on the respective client device 120 to generate a signal, which can cause the client application to perform further operations corresponding to the actionable object.

In some implementations, the graphical user interface can present prompts 170 and messages 180 within the communication session. For example, the graphical user interface can display a message 180 on the odds of a bet or wager in response to a prompt 170 from a client device 120. The client application can be executing on each client device 120 and may be provided to the client device 120 by the data processing system 105 or via an application distribution platform. The graphical user interface can allow players to input prompts 170 related to sports betting, such as requests for odds for upcoming games, the likelihood of a particular team winning a match, or the potential payout for various types of bets (e.g., moneyline, point spread, or over/under). For example, if a player submits a prompt 170 asking for the latest odds on a football game, the client application can present a message 180 that displays the updated moneyline odds, showing which team is favored to win and by how much.

In some implementations, in response to interactions with graphical user interfaces, the client device 120, via the client application and/or the network 110, can send (e.g., transmit) and/or receive information (e.g., data) to the data processing system 105. The data transmitted can include information about prompts 170 (e.g., questions or text input by the users, wager amounts, selections to request information about a status of a contest, etc.).

The machine learning system 125 can include one or more language models 130 and one or more communication application programming interfaces (API) 135. The machine learning system 125 can include any type of computing system that can execute one or more machine learning models, which may include the language model(s) 130 and/or any other machine learning models described herein. The machine learning system 125 can include one or more machine learning models trained on various datasets, including but not limited to datasets for large language models. The machine learning system 125 can include a cloud system, one or more servers, a distributed remote system, or any combination thereof. The machine learning system 125 can include processing components that include, but are not limited to, one or more central processing units (CPUs), one or more graphics processing unit (GPUs), tensor processing units (TPUs), or the like. The machine learning system 125 can include a memory operable to store one or more instructions for operating components of the machine learning system 125 and operating components operably coupled to the machine learning system 125. For example, the instructions can include firmware, software, hardware, operating systems, or embedded operating systems, among others.

In some implementations, the machine learning system 125 can be internal to the data processing system 105. For example, although shown as separate from the data processing system 105, in some implementations the machine-learning system 125 (or the functionality thereof) may be implemented as part of the data processing system. In some implementations, the machine learning system 125 can be external to the data processing system 105 and can be accessed via the network 110, for example, using one or more API keys or authentication processes to process input contexts and/or prompts 170 from the data processing system 105. In some implementations, the machine learning system 125 implement or otherwise provide access to one or more application programming interfaces (APIs), via which the data processing system 105 and/or the client device 120 can access the language model 130 or other functionality of the machine learning system 125.

The language models 130 of the machine learning system 125 can include any artificial intelligence, machine learning, or deep learning models for understanding and generating human language. The language models 130 can include natural language processing (NLP) models such as large language models. The language model 130 can be trained on text data. For instance, the language models 130 can be trained/updated/fine-tuned to perform a variety of text processing tasks, including, but not limited to, generating text, formatting instructions, comprehending and processing natural language input, and responding to queries with contextually relevant information.

The language model 130 can include a transformer architecture, such as a generative pre-trained transformer (GPT) architecture. The transformer architecture can include an encoder that can process the input text and a decoder that can generate the output text. The language model 130 can include multiple layers that can operate to process and generate text. For example, embedding layers can convert words or tokens into dense vectors of fixed size, attention layers can use mechanisms such as self-attention to weigh the importance of different tokens in a sequence, and feedforward layers can apply transformations to the data to learn complex patterns. In some implementations, the language model 130 can use a self-attention mechanism to weight different parts of the input sequence when generating predictions. The language model 130 may be pre-trained (and in some implementations fine-tuned, updated, or re-trained) using large corpuses of natural language text data, such that the language model 130 can efficiently process and provide output corresponding to natural language input.

The language model 130 can receive an input context generated via the model manager 150. As described herein, the input context can include relevant wager opportunities 160 identified based on the prompt 170. The data processing system 105 can transmit the input context to the language model 130. The machine learning system 125 can execute the language model 130 to process the input context. The language model 130 can generate an output data structure including one or more tokens representing an output message generated based on the input context.

The language model 130 can process a wide range of input formats, including but not limited to text, audio, images, video, or other modalities. In some implementations, based on the input context, the language model 130 can generate output, which can range from simple text responses to complex data structures, or combinations thereof. In some implementations, the language model 130 can use the input context to iteratively predict the next token word or phrase to generate responses in response to input contexts. Tokens may include a numerical representation of text data, function calls, special separators/control signals, or any other data described herein. In some implementations, the language model 130 can generate instructions or commands that automatically invoke tools or functions to perform specific tasks or operations.

The language model 130 can receive the additional wagers via the input context. The data structure can include details regarding the wager type (e.g., moneyline, point spread, parlay) and relevant details, such as teams, odds, and bet amounts. In some implementations, the language model 130 can generate an additional data structure or update an existing data structure in response to receiving an input context that includes updated information, such as new odds for a specific wager. The data structure can include a timestamp indicating when the update occurred and a list of changes. For example, each change can specify the field that was modified. The language model 130 can transmit the updated data structure, including the updated wager data, to the client device 120 via the data processing system 105.

Natural language input can have a syntactic structure in which individual words, collections of words (e.g., phrases), or relative positions of words (e.g., word order) can indicate specific meanings. The language model 130 can be trained/updated/fine-tuned to parse sentences into their grammatical components to understand the structure and relationships between words. The language model 130 can use phrasing structure rules that define how words combine to form phrases and sentences. The language model 130 can receive an input context, which can include a sequence of tokens and/or text data structured in a format compatible with an input layer of the language model 130. In some implementations, the language model 130 may include or may be associated with a tokenizer model, which can convert a text-based or media-based input context into a sequence of tokens compatible with an input layer of the language model 130. The input context may include natural language, structured data, or combinations thereof, and may specify instructions for the model to generate particular output according to the techniques described herein.

As described herein, the input context can include relevant wager opportunities 160 identified based on the prompt. The data processing system 105 can transmit the input context to the language model 130. The machine learning system 125 can execute the language model 130 to process the input context. The language model 130 can generate an output data structure including one or more tokens representing an output message generated based on the input context. In some implementations, tokens or combinations of tokens can indicate special control data for the language model, including but not limited to the beginning of prompts/natural language text, or the beginning/end of wager opportunities, deep links, or other types of media modalities, among others.

The communication API 135 of the machine learning system 125 can facilitate interaction between the one or more language models 130 and the data processing system 105. For example, the communication API 135 can receive prompts and/or input contexts provided by the data processing system 105 using prompts 170 from a client device 120 (e.g., text queries, commands, or other forms of input). For example, the communication API 135 can receive input data from a model manager 150. Input data from a model manager 150 can include requests to allow or restrict other input data from being passed on to a language model 130, or requests to allow or restrict responses generated by a language model 130 from being output to a data processing system 105 or client device 120. The communication API 135 can forward the parsed input to a language model 130 for processing. The communication API 135 can retrieve a response generated by a language model 130 after the language model 130 has processed an input. The communication API 135 can format a response generated by a language model 130 into a suitable structure (e.g., JSON, XML) that can be easily understood and utilized by other applications. A communication API 135 can utilize authentication mechanisms (e.g., API keys, OAuth tokens) to verify the identify of a requesting identity to ensure secure communication.

In some implementations, the storage 115 can be a computer-readable memory that can store or maintain any of the information described herein. The storage 115 can store or maintain one or more data structures, which may contain, index, or otherwise store each of the values, pluralities, sets, variables, vectors, numbers, or thresholds described herein. The storage 115 can be accessed using one or more memory addresses, index values, or identifiers of any item, structure, or region maintained in the storage 115. The storage 115 can be accessed by the components of the data processing system 105, or any other computing device described herein, via the network 110. In some implementations, the storage 115 can be internal to the data processing system 105. In some implementations, the storage 115 can exist external to the data processing system 105 and may be accessible via the network 110. The storage 115 can be distributed across many different computer systems or storage elements, and may be accessed via the network 110 or a suitable computer bus interface. The data processing system 105 can store, in one or more regions of the memory of the data processing system 105 or in the storage 115, the results of any or all computations, determinations, selections, identifications, generations, constructions, or calculations in one or more data structures indexed or identified with appropriate values.

Any or all values stored in the storage 115 may be accessed by any computing device described herein, such as the data processing system 105, to perform any of the functionalities or functions described herein. In some implementations, a computing device, such as a client device 120, may utilize authentication information (e.g., username, password, email, etc.) to show that the client device 120 is authorized to access requested information in the storage 115. The storage 115 may include permission settings that indicate which users, devices, or profiles are authorized to access certain information stored in the storage 115. In some implementations, instead of being internal to the data processing system 105, the storage 115 can form a part of a cloud computing system. In such implementations, the storage 115 can be a distributed storage medium in a cloud computing system and can be accessed by any of the components of the data processing system 105, by the one or more client devices 120 (e.g., via one or more user interfaces, etc.), or any other computing devices described herein.

A communication session can enable a player to interact with one or more language models 130, for example, a communication session can be displayed visually on a client device 120. A communication session displayed on a client device 120 (e.g., via graphical user interface) can display one or more data records. For example, a communication session displayed on a client device 120 can display a plurality of prompts 170 transmitted from a client device 120 and a plurality of messages 180 transmitted from a machine learning system 125 in response to one or more prompts 170.

The storage 115 can store wager opportunities 160 for one or more live events 165 (e.g., sports events). The wager opportunities 160 can include event information, identifying the specific live event 165 each wager is tied to, such as participant (e.g., athletes) names, team names, game details, etc. The wager opportunities 160 can include bet options, including different types of bets available for each event, such as moneyline, point spread, or over/under, among other markets. The wager opportunities 160 can include odds, for example, the payout ratio associated with each wager and how much a winning wager would return. The wager opportunities 160 can include an indication of a live event. The live event can function as an identifier or reference, pointing to a specific ongoing live event from the available selections. The wager opportunities 160 can include an indication of a parlay or a single bet recommendation. For example, the wager opportunities 160 can include flags or markers indicating whether a wager is a parlay or a single bet. The wager opportunities 160 can include a record of the number of wagers placed. The wager opportunities 160 can include data corresponding to historical wager opportunities (e.g., past wagers) used to calculate or adjust the odds associated with the current wager opportunities.

In some implementations, odds associated with wager opportunities 160 can be dynamically adjusted based on various factors, such as live event data/developments, fluctuations in betting volume, and historical wager patterns, among others. In some implementations, upon detecting significant events, such as scores or timeouts, the data processing system 105 can recalculate and adjust wager odds. In some implementations, the data processing system 105 can track the popularity of specific wager types or specific wager opportunities, such as single game parlays, quick single game parlays (Quick SGPs), by tracking the number of times the corresponding wager types/opportunities have been selected. For example, each wager opportunity 160 can include or be associated with a counter that is incremented each time the wager opportunity is placed by a player via the data processing system 105.

In some implementations, the storage 115 can store or otherwise maintain one or more prompts 170 in one or more data structures. A prompt 170 can be transmitted by a client device 120 in response to one or more interactions with an application executing on the client device 120. A prompt 170 can include text data from various sources, including a string or plurality of numbers, letters, characters, or any combination of numbers, letters, and characters. A prompt 170 can include data in one or more data structures. For example, a prompt 170 can include data that may be classified as corresponding to one or more intents 185. Prompts 170 transmitted by client devices 120 can be displayed on a client device 120, for example, during the communication session to which it corresponds.

In some implementations, the prompt 170 can be a string of natural language text, such as a question, command, data related to wager opportunities, or statement, that the player provides via interaction(s) at the client device 120 or client application to communicate with the data processing system 105. For example, a prompt 170 can include, “what are the odds for today's football game?”. The prompt 170 can include numerical input, such as a request that include calculations or comparisons. The prompt 170 can be a request to perform an action, such as initiating a process, retrieving data, identifying wager recommendations, identifying application interfaces and/or webpages, generating any other information as output. The user can input a prompt 170 asking to “generate a report of all the football game scores of games played this week”. The prompt 170 can include follow-up texts to a previous interaction, where the user continues an ongoing conversation with the language model 130 (e.g., the prompt can include “Can you provide more details?”).

The storage 115 can store one or more datasets 172. The dataset 172 can include a collection of structured data by the machine learning system 125 and/or the language model 130 (or other machine learning models described herein) to perform specific tasks. The data processing system 105 can collect data from sources such as sports data providers, betting platforms, player interactions, and more, through data extraction. The data processing system 105 can address missing values, inconsistencies, and outliers to maintain data quality, for example, through data cleaning or preprocessing. The data processing system 105 can aggregate data from multiple sources to generate the dataset 172. In some implementations, the data processing system 105 can generate additional training examples for datasets 172, for example, using data augmentation techniques.

The dataset 172 can include attributes 175 for participants (e.g., athletes) and teams (e.g., sports teams). The attributes 175 can be structured data. Attributes 175 for participants can include individual athlete statistics, demographics, position, and status. Athlete attributes 175 can include numerical data such as goals scored, assists, tackles made, and average game rating. Athlete attributes 175 can include historical or numerical data such as recent performance scores, athlete age, height, and weight. Athlete attributes 175 can include categorical information such as the position the athlete plays (e.g., in a soccer game: striker, defender, goalkeeper). Athlete status attributes 175 can include categorical or string data such as whether the athlete is active, injured, or suspended.

Attributes 175 for teams (e.g., team attributes 175) can include data related to team rankings, performance, lineup, strategy, and history, among others. Team attributes 175 can include current league rankings (e.g., 1st, 2nd, 3rd). Team attributes 175 can include the number of wins, losses, draws, and goals scored in recent matches. Team attributes 175 can include categorical data such as formation type (e.g., 4-3-3 or 3-5-2 in soccer) and overall playing style (e.g., attacking, defensive, or balanced). Team attributes 175 can include historical or relational data, such as a team's previous matches against specific opponents and their historical performance in tournaments. For example, historical team attributes can include team's win-loss record from previous seasons or team performances in past tournaments. Attributes 175 can be preprocessed to ensure completeness (e.g., through data cleaning or preprocessing).

The storage 115 can store or otherwise maintain one or more messages 180 in one or more data structures. Each message 180 can be generated by one or more language models 130 and transmitted via one or more communication APIs 135 to the data processing system 105 (or any components thereof). A message 180 may be an output message generated by the language model 130 and/or the machine learning system 125. The message 180 may include text data, such as letters, characters, or any combination of numbers, letters, and characters. For example, when a prompt 170 and/or supplemented input context is received, the language model 130 can processes the input context and generates a message 180 that contains relevant data or information as a response (e.g., wager opportunities 160). Records of conversations including both prompts 170 and corresponding messages 180 can be stored in one or more data structures as a historical record of one or more communication sessions.

The storage 115 can store or otherwise maintain one or more intents 185 in one or more data structures. An intent 185 can be generated the data processing system 105 or by a language model 130. For example, an intent 185 can be generated by a request receiver 145 and/or model manager 150. An intent 185 can be generated in response to a determination by a language model 130. An intent 185 can be generated for a corresponding prompt 170 or set of prompts 170 transmitted during a communication session. An intent 185 can indicate the purpose or For example, a prompt 170 can have an intent 185 associated with a request for wagers, which may include a wager for particular sport(s), live event(s), team(s), participant(s), wager type(s), or any other intent information. The intent 185 may be a request for information, a request to update wager opportunities, player profile information, bet slips, or any other information described herein.

The data processing system 105 and/or the language model 130 within the machine learning system 125 can generate the intent 185 and store the intent 185 in the storage 115 for further use. The intent 185 can be determined from factors within the communication sessions, such as the content of prompts 170, and in some implementations further based on one or more messages 180 and/or input contexts that are intended to be provided to the language model 130 for processing. An intent 185 can be determined or derived from a prompt 170, the content of a message 180 or prompt 170, the length of the message 180 or prompt 170, the number of messages 180 or prompts 170, or the number of a subset of messages 180 or prompts 170 within a communication session, among other factors.

In some implementations, the data used for processing wager opportunities and the data used to generate the message 180 can be structured differently. For example, for parlay wager opportunities, the message 180 can hierarchical layouts or graphical elements, in some implementations. In some implementations, the message 180 can include interactive elements such as buttons or links that, when clicked or interacted with, automatically cause the application presenting the interactive elements to transmit requests to place one or more wagers corresponding to the wager opportunities 160.

In some implementations, the language models 130 and/or the machine learning system 125 can implement additional or alternative NLP techniques to determine or extract intents 185 from prompts 170. For example, additional machine learning models including transformers, recurrent neural networks (RNNs), named entity recognition (NER), and sentiment analysis models may be used to generate classification(s) of intents 185 for one or more prompts 170. The NLP techniques can be used to process and analyze the text of a prompt 170 to determine the intent 185. NLP techniques can include breaking down a prompt 170 into multiple phrases or segments based on word choice, sentence structure, and context.

In one example, tokenization can be used to break down a prompt 170 into individual words or phrases, which can be processed by the language model 130 or other machine learning models to implement syntactic and semantic analysis and to determine an intent 185. The language models 130, via NLP techniques, can determine the intent 185 across multiple prompts 170 within the same communication session 160. For example, if a player submits multiple prompts 170 about sports betting odds, the data processing system 105 can determine an intent 185 related to sports betting even if keywords are not repeated in every prompt 170. The use of NLP techniques can enhance the ability of the data processing system 105 to interpret complex prompts 170, ensuring that intents 185 are accurately determined. In another example, if the player submits the prompt 170, “What are the odds for Team A tonight?”, the secondary language model can analyze the prompt 170 and classify the intent 185 as a request for odds information of one or more wagers for “Team A”.

In some implementations, a prompt 170 or set of prompts 170 in a communication session can be classified as relating to a request for information relating to the attributes 175 of one or more participants or teams. As described in further detail herein, a prompt 170 may be classified as including an intent 185 indicating a request for a participant or team having certain attributes, which may further include an intent 185 relating to a request for a wager opportunity. Any type or combination of intents 185 can be derived from any number of prompts 170 and/or messages 180 provided in a communication session. In some implementations, the intent 185 can indicate the type of attributes, participant identifiers, team identifiers, or any other information that may be extracted from the prompt(s) 170 and/or message(s) 180 that can be used to identify information relating to one or more attributes 185.

Referring now to the operations of the data processing system 105, the storage maintainer 140 can maintain a plurality of wager opportunities 160 that correspond to one or more live events 165 (e.g., sport events, any other event that may involve wagering). The one or more live events may include events that are currently live or upcoming events that are to occur live. The storage maintainer 140 can store the wager opportunities 160 in the storage 115. Each of the plurality of wager opportunities 160 can identify at least one of a plurality of teams. For example, a wager opportunity 160 for a soccer game can identify “Team A” and “Team B”, and can offer options to bet on the outcome of the soccer match, such as which team will win (moneyline) or how many goals each team will score (over/under). The storage maintainer 140 can maintain in the storage 115 a plurality of wager opportunities 160 identifying at least one of a plurality of participants in the live events 165. For example, in a basketball game, wager opportunities 160 can include wagers on participants (e.g., athletes), such as predicting how many points a participant will score or whether a participant will achieve a triple-double.

The storage maintainer 140 can maintain, in the storage 115, a dataset 172 identifying one or more participant attributes 175 of the plurality of participants and one or more team attributes 175 of the plurality of teams. By maintaining the dataset 172, the storage maintainer 140 can access data identify wager opportunities 160 in response to prompts 170 having an intent 185 corresponding to participant/team attributes 175. The dataset 172 can be organized in a structured data format. The storage maintainer 140 can access and query the dataset 172 through unique identifiers, such as participant names, team names, or live event identifiers (e.g., IDs). The one or more team attributes 175 can include a ranking of each of the plurality of teams (e.g., “Team A” is ranked 1^{st} in the league, or “Team B” is ranked 5^{th}). The one or more team attributes 175 can include a performance of a team in one or more historical live events, such as the number of wins or losses in a team's past games (e.g., number of wins of a team in the team's last 10 games). The one or more team attributes 175 can include a type of sport in which each of the plurality of teams participate (e.g., soccer, basketball, football, etc.). The storage maintainer 140 can store in the storage 115 participant attributes 175 that include a ranking of each of the plurality of participants, such as “Athlete A” being ranked as the top scorer in a league or “Athlete B” ranked 3rd in assists. The participant attributes 175 can include performance metric (e.g., “Athlete A” scoring 30 points in their last game). The participant attributes 175 can include associations with teams (e.g., “Athlete A” being a member of “Team X”).

The data processing system 105 can include the request receiver 145. The request receiver 145 can be or include any script, file, program, application, set of instructions, or computer-executable code that is configured to process input data in the form of a prompt 170. The request receiver 145 can include hardware, software, or any combination. A prompt 170 can include any player-provided command, request, or text data. The prompt 170 can include a request or information relating to wager recommendations, live events, participants, teams, or other types of requests. The prompts 170 can include any type of information that may be used to classify the intent 185 of the prompt 170, including but not limited to an indication of a wager type, a wager amount, or indications of live events, participants, teams, or outcomes. The request receiver 145 can receive the prompt 170 from the client device 120 in natural language (e.g., a text string). The request receiver 145 can receive prompts 170 through player interactions with the application interface. Player interactions can include clicking buttons, entering text, or using voice commands within one or more application interfaces, among others. In some implementations, the request receiver 145 can identify specific events or triggers, such as player actions or system state changes, which can generate prompts 170.

In some implementations, the request receiver 145 can receive, from the client device 120, a prompt 170 that includes a request for a wager opportunities 160 (e.g., wager recommendation). For example, a player can submit a prompt 170 asking for the best wager on an upcoming football match, or a specific athlete's performance in the next basketball game. The request can specify or otherwise indication a corresponding attribute 175, about at least one of a participant or a team. The request can specify an attribute 175 corresponding to at least one of a participant or a team. The request can include a specific attribute, such as a performance metric (e.g., points scored, assists, or goals). For example, the request and/or prompt 170 can include “Show the athlete with the highest points scored.” The request can in include attributes indirectly by referencing a ranking, status, or position (e.g., current league ranking, active/injured status), such as the request and/or prompt 170 “Show the top-ranked team with least injured players”. Additionally, the request can identify an attribute based on historical performance, such as recent wins/losses or a player's form over a series of games, or by specifying associations, such as team membership or position within a team.

The request receiver 145 can receive and process the prompt 170 and/or the request to allow the data processing system 105 to generate a response (e.g., wager opportunity 160) based on relevant data. The request receiver 145 can receive the request, via the prompt 170, and can identify at least one attribute 175 by parsing and analyzing the content of the prompt 170. The request receiver 145 can extract key terms or phrases that correspond to attributes 175. The request receiver 145 can use natural language processing techniques described herein to determine the attributes 175 corresponding to an intent 185 of the prompt 170.

In some implementations, the request receiver 145 can parse and process the prompts 170 and/or the request to extract information, such as attributes 175, wager type, amount, and game selections, among others. The request receiver 145 can execute functions in response to receiving a prompt 170. The request receiver 145 can provide a prompt 170, the request, and any information extracted therefrom, to other components of the data processing system 105 and/or the machine learning system 125 for further processing according to the techniques described herein. The request receiver 145 can format the prompt 170 into a standardized data structure, in some implementations. The request receiver 145 can collect or store records of player prompts 170 in the storage 115. In some implementations, the data processing system 105 can store and/or process the conversation to generate data of the datasets 172 to improve the classification accuracy of one or more machine learning models.

The request can include or otherwise indicate a request corresponding to an attribute 175 of a participant or a team maintained by the data processing system 105. For example, the request can include an attribute 175 stated implicitly. An intent 185 can identify or otherwise indicate the attributes 175 of the request. In some implementations, an intent 185 can be generated by the request receiver 145 and/or model manager 150 based on the prompt 170 and the request. The intent 185 can be generated in response to a determination by a language model 130. The intent 185 can determine the underlying meaning of the request, including requested/indicated attributes 175 for participants and teams. For example, the prompt 170 “Who is performing well lately?” may generate an intent 185 corresponding to recent performance attributes 175 of participants or attributes 175 of teams (e.g., points scored, assists). A request such as “Which team has the best defense?” can trigger the intent 185 to identify attributes related to team defense performance (e.g., goals conceded, defensive ranking, etc.). A prompt 170 can have an intent 185 associated with a request for wagers, which may include a wager for particular sport(s), live event(s), team(s), participant(s), wager type(s), or any other intent information. The intent 185 may be a request for information, a request to update wager opportunities, player profile information, bet slips, or any other information described herein.

The request receiver 145 can determine that the request includes an attribute 175 request for wager opportunities corresponding to one or more top-ranking players. For example, if the prompt 170 includes phrases like “Who are the top athletes this season?” or “Show me the highest-ranked athletes,” the request receiver 145 can determine that the intent 185 is an interest in athlete rankings or performance metrics. The request receiver 145, via the language model 130, can analyze the prompt for keywords like “top,” “best,” or “highest-ranked.” The request receiver 145 can access the dataset 172 and retrieve participant attributes 175, such as the latest rankings of participant, participant scoring averages, or assists, among others.

The data processing system 105 can include the model manager 150. The model manager 150 can be or include any script, file, program, application, set of instructions, or computer-executable code that is configured to determine the classification of the request included in a player input, referred to as a prompt. Similar to the request receiver 145, the model manager 150 can parse prompts received from the client device 120 to determine an intent 185 of the prompts 170. In some implementations, the model manager 150 can use one or more language models 130 to classify or determine the intent(s) 185 of a prompt 170. For or a given prompt, the data processing system 105 can use the model manager 150 to generate an input context for the language model 130 using the prompt and the classification of its intent(s) 185. The input context can include a variety of information, such as prompts, questions, or previous parts of a conversation. The model manager 150 can identify the desired action or information sought by the player.

In some implementations, the model manager 150 can use rule-based techniques to identify player intents 185. For example, the model manager 150 can use a set of predefined rules or patterns that match specific prompts to predefined intents. In some implementations, the model manager 150 can use keyword matching or regular expressions to identify patterns that capture variations in prompts. For example, a rule can specify that a prompt related to placing a wager may indicate a betting intent. In some implementations, the model manager 150 can use machine learning models to identify a wider range of intents, including those that are context-dependent or ambiguous. For example, the model manager 150 can use implement vector machines (SVMs), naive bayes, or deep learning architectures such as recurrent neural networks (RNNs), or language models including transformer models such as BERT, DistilBERT, or generative pre-trained transformer (GPT)-based models. The models can be trained on large datasets of player prompts and their corresponding intents. The model manager 150 can use the machine learning model(s) (e.g., machine learning system 125) to distinguish between player intents 185, such as checking odds, placing wagers, requesting wager recommendations or information based on attributes 175 of participants or teams, or requesting payouts, among other prompts.

The model manager 150 can process prompts 170 to classify/determine the underlying intent 185 or purpose. The model manager 150 can categorize the player's prompt 170 into specific intents, such as placing a bet, checking odds, or requesting information about a specific participant attributes 175 or team attributes 175. The model manager 150 can determine the actions to fulfill the player's request based on the classified intent. For example, if a player enters the prompt “What are the odds for Team A to win tonight?”, the model manager 150 can determine that the prompt is a request for wagering information, identify the specific wager type as a moneyline bet, and extract attributes 175 such as the team's name (in this example, Team A) and the game timeframe (in this example, tonight).

The request receiver 145 and/or model manager 150 can select a subset of the plurality of wager opportunities 160 that identify one or more participants from the plurality of participants that satisfy the attribute 175 request (e.g., top athletes). This process involves filtering through the available wager opportunities to find those specifically linked to the requested attributes, such as player rankings or performance metrics. For instance, if the request indicates an interest in top-performing players, the request receiver can search/filter the wager opportunities to include only those that feature players meeting criteria corresponding to one or more attributes 175 identified in the classified intent 185 of the prompt(s) 170, such as being among the top five scorers in the league or achieving a specific average points per game.

In some implementations, the model manager 150 may generate an input context for the language model 130 by retrieving various additional information relating to the intent 185 of the prompt, including but not limited to data of one or more wager opportunities, data from one or more webpages, information corresponding to one or more attributes 175, application interfaces, or information sources, odds information for one or more wager opportunities, player profile information, historical wagering information for one or more live events, teams, live event participants, or other data, among any other information that may be processed by the language model 130. The input context may be a sequence of characters, tokens, or structured data that is to be provided as input to the language model 130. Data can be provided to the language models 130 via the communication APIs 135 of the machine learning system 125, in some implementations. Messages 180 generated by the language model 130 can be received by the model manager 150 and/or the output provider 155, as described herein, and may be provided for presentation at the client device 120 communicating.

The model manager 150 can generate, using the language model 130, the prompt 170, and at least a portion of the dataset 172 (e.g., attributes 175), an output message 180 identifying at least one wager opportunity 160 from the plurality of wager opportunities selected based on the requested attribute 175. For example, if a player submits the prompt 170 “Wager on the best team in the English League,” the model manager 150 can analyze this prompt 170 to identify the requested attribute 175 as the standings or rankings of top teams in the league. The model manager 150 can, using the machine learning system 125 and/or language model 130, recognizing that the term “the best” can refer to a top-performing or elite team within the context of the English league. The model manager 150 can determine that the intent 185 is to receive a wager opportunity 160 on the top English soccer team. Rather than explicitly indicating a particular attribute 175 or group of attributes 175, the prompt 170 can indicate one or more implicit terms for the attributes, such as a name/identifier of a player, team, or concept that indicates the attribute(s) 175.

The model manager 150, in generating the input context for the prompt 170, can retrieve relevant team attributes 175 by querying the dataset 172 for attributes 175 related to the intent of the prompt 170. The model manager 150 can sort teams and/or participants based on attributes 175. Furthering the example above, the model manager 150 can identify the attributes 175 that measure the performance of different teams in the English League. As the intent of the prompt 170 indicates that “the best” team is to be identified, the model manager 150 can sort/rank each of the teams identified as members of the English League to identify which teams have the highest-ranking attributes 175. For example, the model manager 150 can query the dataset 172 for team attributes 175 (e.g., win-loss records, team performance metrics, historical data, goals scored). In some implementations, the model manager 150 can execute queries over the dataset 172 according to particular attributes identified or inferred from the prompt(s) provided as described herein. The model manager 150 can apply filters to limit the dataset 172 to teams and/or participants that satisfy inferred to classified criteria extracted from the attributes 175 (e.g., as provided by the language model 190 and/or classified from the intent of one or more prompts).

The model manager 150, via the machine learning system 125 and/or language model 130, can map extracted keywords, phrases, or indications from the prompt 170 and/or intent 185 to specific attributes 175 in the dataset 172. For example, the model manager 150 can link “best athlete” to participant attributes 175 with highest scoring average. The mapping may further provide different mappings for different live event types (e.g., different sports), participants, teams, or other factors that may affect the context or semantic meaning of the keywords, phrases, or indications. In some implementations, the semantic classification techniques described herein may be implemented to identify the mapping(s) between keywords, phrases, or indications in prompts and corresponding attributes 175 in the dataset 172.

In some implementations, the model manager 150 can search or perform one or more selection/identification actions using the attributes based on one or more keywords, phrases, or indications in the prompt and/or in the intent 185. In one example, if the prompt indicates a “best,” “top,” “worst,” or other word/phrase that can be semantically classified as corresponding to a ranking, the model manager 150 can sort the attributes 175 data in the dataset 172 based on rank of relevant attributes 175. The model manager 150, via the machine learning system 125 and/or language model 130, can determine the relevant attributes 175. The model manager 150 can combine or cross-reference more than one attributes 175 (e.g., combining scoring averages and assists) for each team and/or participant. For example, when a player submits a prompt 170, “Who is the best basketball player this season?”, the model manager 150 can extracts keywords such as “best” and “basketball player” from the prompt 175. The model manager 150, via the machine learning system 125 and/or language model 130, can map the keywords, phrases, or indications to participant attributes 175 (e.g., scoring average, assists per game, athlete height, etc.). Furthering this example, the model manager 150 can query/search the attributes 175 to retrieve data for basketball players based on the identified attributes (e.g., the model manager 150 can sort the athletes by their scoring averages and assists per game, combines the scoring averages and assists to create a composite score, etc.).

Upon identifying the top-ranking team(s), to satisfy the request indicated in the intent 185 of the prompt 170, the model manager 150 can identify one or more wager opportunities 160 corresponding to the identified top-ranking team(s). Data of each of the identified wager opportunities 160 can be included in the input context with the prompt 170, in addition to other information (e.g., the attribute(s) 175 corresponding to identified team(s)/participant(s), other information relating to the intent 185 of the prompt 170, etc.). The generated input context can be provided as input to the language model 130, for example, by transmitting the input context to the machine learning system 125 via the communication API 135.

In some implementations, the model manager 150 can select a subset of the wager opportunities 160 that identify one or more participants and/or teams that satisfy the attribute 175 indicated in the request/prompt 170. The attribute(s) 175 can be determined from the intent 185, as described herein. The model manager 150 can access the attribute 175 data from the dataset 172. The model manager can filter through the wager opportunities 160 to identify wager opportunities 160 that match the requested attributes 175. For example, if the player prompt intent is on top-performing soccer athletes, the model manager 150 can search for wager opportunities 160 identifying participants having those attributes 175.

The model manager 150 can generate an output message 180 based on the input context including player prompt 170. For example, the output message 180 may state, “Did you mean the best teams in the English league? If so, here is a list of the top teams: Team A, Team B, and Team C. Wager opportunity: Bet on Team B to score in the next match.” The output message 180 can be generated as a natural language output that indicates the intent 185 of the prompt and provides relevant information about the top teams/participants (in this example) and a specific wager opportunity 160.

In some implementations, the model manager 150 can select a subset of the wager opportunities 160 that identify one or more participants of the plurality of participants that satisfy the attribute 175 request. The model manager 150 can select a subset of the plurality of wager opportunities 160 by determine the intent 185 of the request. The attribute 175 can be determined from the intent 185. The model manager 150 can access the attribute 175 data from the dataset 172. The model manager can filter through the wager opportunities 160 to identify wager opportunities 160 that match the requested attributes 175. For example, if the player prompt intent is on top-performing soccer athletes, the model manager 150 can search for wager opportunities associated with such participants attributes.

In some implementations, upon receiving a prompt (e.g., a first prompt), the model manager 150 can process the input to identify the player's intent 185, by processing keywords, entities, or semantic meaning. In some implementations, later in the communication session (e.g., after the data processing system 105 generates/provides one or more messages 180 according to the techniques described herein), the player can transmit a second prompt 170 to the data processing system 105 (e.g., via the request receiver 145). The model manager 150 can process the first, second, or in some implementations further prompts 170 in a communication session to refine, update, and/or identify player's intent 185. For example, if the first prompt reads “Odds for,” and the second prompt reads “Team A baseball game tonight,” the model manager 150 can determine that the player intends to request one or more wager opportunities 160 for tonight's baseball game for Team A. The data processing system can process the original and subsequent prompts to extract relevant information. For example, based on the combined prompts, the data processing system can extract relevant information about the desired wager type, teams, and specific betting options, among others.

The model manager 150 can generate, using the language model 130 and a second prompt 170, a second output message comprising a first wager opportunity 160 of the plurality of candidate wager opportunities 160. The first wager opportunity can be selected based on the second requested attribute. For example, if the first prompt 170 reads “best basketball athlete” and the model manager identifies that Alex Collie is currently one of the top-rated basketball athlete based on recent performance and statistics indicated in the attributes 175, the model manager 150 can identify one or more wager opportunities 160 identifying Alex Collie. The model manager 150 can include the one or more wager opportunities 160 in an input context for the language model 130 to recommend the one or more wager opportunities 160, generating a corresponding output message 180 such as, “Here is a best basketball athlete selection for Alex Collie: Over 28 Total Points. A winning $10 bet would have a total payout of $19.15.” If the player then asks, “What about Alex Collie of hockey?” the model manager 150 can analyze this second prompt 170 to determine the intent 185 of the subsequent prompt 170.

Using named-entity extraction and semantic analysis techniques described herein, the model manger 150 can determine that the second prompt 170 requests information relating to the top-rated hockey player, as indicated in the attributes 170 of the dataset 172. and identify a corresponding athlete in hockey. The second output message can include, “The best hockey player with similar attributes to Alex Collie is Liam Smith. Would you like to place a wager on Liam Smith for the upcoming game?”. The model manager 150 can generate the output message 180 by providing the input context to the language model. As described herein, the input context can include any provided prompts 170, previous interactions/messages, requests, as well as retrieved wager opportunities 160 and/or identified attributes 175 can be formatted into an input context data structure and provided to an input layer of language model 130 to generate an output message 180.

The output provider 155 can receive any messages 180 generated by the language model 130 in response to providing one or more prompt(s) 170 and/or input contexts to the language model 130 for processing. In some implementations, the output provider 155 can format the response messages 180 received via the communication API 135 into a suitable structure that allows it to be displayed on a client device 120. In some implementations, the output provider 155 can display messages 180 in JSON or XML structure.

FIGS. 2A-2B illustrate example user interfaces of an application executing on a client device presenting a communication. Referring to FIG. 2A in the context of the components described in connection with FIG. 1, illustrated is an example diagram 200A showing a graphical user interface 202. The graphical user interface 202 can be displayed as part of the communication session. The graphical user interface 202 can be displayed on the client device 120. The graphical user interface 202 can include an input field 215 that can receive input (e.g., prompt 170) from the user (e.g., player). The graphical user interface 202 can include a send button 220 that can initiate the transmission or sending of the input (e.g., prompt 170) from the client device to the computing system providing the communication session (e.g., the data processing system 105).

In this example, the player has provided prompts 205A-205C. The graphical user interface 202 can display, via data received from the data processing system 105, messages 210A-210D (e.g., messages 180) generated based on the prompts 205A-205C. For example, prompt 205A can be a prompt requesting information about the best basketball player. The data processing system 105 can receive the prompt 205A and determine that the request is for the top-performing participant (e.g., athlete) in the game of basketball based on statistics and performance data stored in the dataset (e.g., dataset 172). The data processing system 105 can search in the dataset 172 for attributes (attributes 175) of participants (e.g., athletes) in the game of basketball to determine the best participant (i.e., athlete). Based on analysis (e.g., statistical analysis, machine learning prediction, etc.) on participant attributes data from the dataset 172, the data processing system 105 can identify “Alex Collie” as the best basketball player. The graphical user interface 202 can display a message 210A which responds to the player question and can offer to suggest wager options.

As shown, the graphical user interface 202 can display a prompt 205B based on the player's interaction with a message bar 215. The player can enter a prompt 205B that reads “Alex Collie Over Points”, indicating a request for a wager opportunity related to Alex Collie scoring more than a certain number of points.

The data processing system 105 can receive text data entered into the prompt 205B as a prompt from the client device 120 over the network 110. The data processing system 105 can determine the classification of the intent of the request included in the prompt 205B, such as identifying the desired wager type and relevant player or team. The data processing system 105 can generate an input context for the language model 130 based on the classified prompt. The language model 130 can process the input context (which can include the prompt, identified wager opportunity data, etc.) to generate a data structure corresponding to one or more wager opportunities. For example, the data structure can include information such as the wager type, participants, and relevant metrics, among others. The client device 120 can parse the data structure to display a specific wager option 210B via the graphical user interface 202, such as “Alex Collie Over 28 Total Points”, along with an additional output such as “Here is your selection for Alex Collie Over 28 Total Points. A winning $10 bet would have a total payout of $19.15”. The graphical user interface 202 can display the odds 212 associated with the generated wager option 210C. The odds 212 can indicate betting dynamics. For example, negative odds, such as −115, can indicate that the player is to wager $115 to win $100, and positive odds can indicate the potential winnings from a $100 wager.

In FIG. 2B, when a player submits the prompt 205C “What about Alex Collie of hockey?” the data processing system 105 can identify the player's intent regarding top-performing hockey players and determine information about a hockey player with attributes similar to those of Alex Collie, who is identified as a top athlete in basketball. The graphical user interface 202 can display a message 210D about Liam Smith who is a top athlete in hockey. The data processing system 105 can generate the output message 210D to include candidate wager opportunities selected based on a similarity between the candidate wager opportunity and at least one attribute, along with an additional output such as “Here is a selection for Liam Smith Over 40 Total Points. A winning $10 bet would have a total payout of $50”. The graphical user interface 202 can display the odds 214 associated with the generated wager option 210E. The odds 214 can indicate betting dynamics.

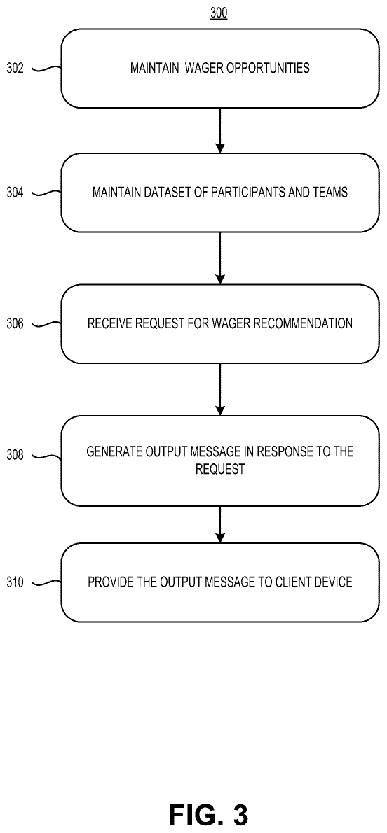

Referring to FIG. 3, illustrated is an example flow diagram of a method 300 for identifying real-time network data structure associations using language models, in accordance with one or more implementations. In brief overview of the method 300, the data processing system (e.g., the data processing system 105, etc.) can maintain one or more wager opportunities for one or more live events (e.g., sport game or match) (STEP 302), maintain a dataset identifying one or more participant (e.g., sport athletes) attributes and/or one or more team (e.g., sport team) attributes (STEP 304), receive from a client device a prompt comprising a request for a wager recommendation (STEP 306), generate an output message identifying at least one wager opportunity based on the requested attribute(s) (STEP 308), and provide the output message to the client device in response to the request (STEP 310).

In further detail of method 300, at STEP 302, the data processing system can maintain a plurality of wager opportunities (e.g., multiple betting options) corresponding to a plurality of live events (e.g., ongoing or upcoming sport games). Each of the plurality of wager opportunities can include identifying at least one of a plurality of teams or a plurality of participants of one or more live events (e.g., each betting option can be associated with one or more teams and/or one or more participants). The participants can include sports athletes or sports game participants. Each of the plurality of wager opportunities can include multiple teams or participants within a single live event or across multiple live events.

At STEP 304, the data processing system can maintain a dataset identifying one or more participant attributes of the plurality of participants and one or more team attributes of the plurality of teams. The dataset can include attributes (e.g., information or details) related to participants and teams involved in the live events. The dataset can include participant attributes such as participant statistics, performance, demographics, and/or status. For example, a dataset can include data on participant John Smith in a soccer match such as that he has scored 5 goals in his last 3 games, is 25 years old, and plays as a striker. The dataset can include team attributes such as team rankings, team performance, team strategy, and/or team history (e.g., historical performance in live events or against specific opponent teams). The dataset can include numerical data (e.g., integer or real numbers), categorical data (e.g., active, injured, suspended), strings, etc.

At STEP 306, the data processing system receive, from a client device (e.g., smartphone, tablet, or computer), a prompt comprising a request for a wager recommendation. A player can send the prompt from the client device. The prompt can include a bet or wager based on criteria or attributes related to a team or participant. The request can identify a requested attribute of a participant of the plurality of participants or a team of the plurality of teams.

At STEP 308, the data processing system can generate, using a language model, the prompt, and at least a portion of the dataset, an output message identifying at least one wager opportunity of the plurality of wager opportunities selected based on the requested attribute. The language model can include a natural language processing model (e.g., GPT) to interpret the player's request (e.g., prompt) and analyze the prompt for wager opportunities. The wager opportunities can include betting options derived from the player's request and the relevant sports data. At STEP 310, the data processing system can provide the output message to the client device in response to the request.

Various operations described herein can be implemented on computer systems. FIG. 4 shows a simplified block diagram of a representative server system 400, client computer system 414, and network 426 usable to implement certain implementations of the present disclosure. In various implementations, server system 400 or similar systems can implement services or servers described herein or portions thereof. Client computer system 414 or similar systems can implement clients described herein. The system (e.g., the data processing system 105A) and others described herein can be similar to the server system 400.

Server system 400 can have a modular design that incorporates a number of modules 402; while two modules 402 are shown, any number can be provided. Each module 402 can include processing unit(s) 404 and local storage 406.

Processing unit(s) 404 can include a single processor, which can have one or more cores, or multiple processors. In some implementations, processing unit(s) 404 can include a general-purpose primary processor as well as one or more special-purpose co-processors such as graphics processors, digital signal processors, or the like. In some implementations, some or all processing units 404 can be implemented using customized circuits, such as application specific integrated circuits (ASICs) or field programmable gate arrays (FPGAs). In some implementations, such integrated circuits execute instructions that are stored on the circuit itself. In other implementations, processing unit(s) 404 can execute instructions stored in local storage 406. Any type of processors in any combination can be included in processing unit(s) 404.

Local storage 406 can include volatile storage media (e.g., DRAM, SRAM, SDRAM, or the like) and/or non-volatile storage media (e.g., magnetic or optical disk, flash memory, or the like). Storage media incorporated in local storage 406 can be fixed, removable or upgradeable as desired. Local storage 406 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 404 need at runtime. The ROM can store static data and instructions that are needed by processing unit(s) 404. The permanent storage device can be a non-volatile read-and-write memory device that can store instructions and data even when module 402 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some implementations, local storage 406 can store one or more software programs to be executed by processing unit(s) 404, such as an operating system and/or programs implementing various server functions such as functions of the data processing systems 105.

“Software” refers generally to sequences of instructions that, when executed by processing unit(s) 404 cause server system 400 (or portions thereof) to perform various operations, thus defining one or more specific machine implementations that execute and perform the operations of the software programs. The instructions can be stored as firmware residing in read-only memory and/or program code stored in non-volatile storage media that can be read into volatile working memory for execution by processing unit(s) 404. Software can be implemented as a single program or a collection of separate programs or program modules that interact as desired. From local storage 406 (or non-local storage described below), processing unit(s) 404 can retrieve program instructions to execute and data to process in order to execute various operations described above.

In some server systems 400, multiple modules 402 can be interconnected via a bus or other interconnect 408, forming a local area network that supports communication between modules 402 and other components of server system 400. Interconnect 408 can be implemented using various technologies including server racks, hubs, routers, etc.

A wide area network (WAN) interface 410 can provide data communication capability between the local area network (interconnect 408) and the network 426, such as the Internet. Technologies can be used, including wired (e.g., Ethernet, IEEE 802.3 standards) and/or wireless technologies (e.g., Wi-Fi, IEEE 802.11 standards).

In some implementations, local storage 406 is intended to provide working memory for processing unit(s) 404, providing fast access to programs and/or data to be processed while reducing traffic on interconnect 408. Storage for larger quantities of data can be provided on the local area network by one or more mass storage subsystems 412 that can be connected to interconnect 408. Mass storage subsystem 412 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 412. In some implementations, additional data storage resources may be accessible via WAN interface 410 (potentially with increased latency).

Server system 400 can operate in response to requests received via WAN interface 410. For example, one of modules 402 can implement a supervisory function and assign discrete tasks to other modules 402 in response to received requests. Work allocation techniques can be used. As requests are processed, results can be returned to the requester via WAN interface 410. Such operation can generally be automated. Further, in some implementations, WAN interface 410 can connect multiple server systems 400 to each other, providing scalable systems capable of managing high volumes of activity. Techniques for managing server systems and server farms (collections of server systems that cooperate) can be used, including dynamic resource allocation and reallocation.

Server system 400 can interact with various user-owned or user-operated devices via a wide-area network such as the Internet. An example of a user-operated device is shown in FIG. 4 as client computing system 414. Client computing system 414 can be implemented, for example, as a consumer device such as a smartphone, other mobile phone, tablet computer, wearable computing device (e.g., smart watch, eyeglasses), desktop computer, laptop computer, and so on.

For example, client computing system 414 can communicate via WAN interface 410. Client computing system 414 can include computer components such as processing unit(s) 416, storage device 418, network interface 420, user input device 422, and user output device 424. Client computing system 414 can be a computing device implemented in a variety of form factors, such as a desktop computer, laptop computer, tablet computer, smartphone, other mobile computing device, wearable computing device, or the like.

Processor 416 and storage device 418 can be similar to processing unit(s) 404 and local storage 406 described above. Suitable devices can be selected based on the demands to be placed on client computing system 414; for example, client computing system 414 can be implemented as a “thin” client with limited processing capability or as a high-powered computing device. Client computing system 414 can be provisioned with program code executable by processing unit(s) 416 to enable various interactions with server system 400 of a message management service such as accessing messages, performing actions on messages, and other interactions described above. Some client computing systems 414 can also interact with a messaging service independently of the message management service.

Network interface 420 can provide a connection to the network 426, such as a wide area network (e.g., the Internet) to which WAN interface 410 of server system 400 is also connected. In various implementations, network interface 420 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 422 can include any device (or devices) via which a user can provide signals to client computing system 414; client computing system 414 can interpret the signals as indicative of particular user requests or information. In various implementations, user input device 422 can include any or all of a keyboard, touch pad, touch screen, mouse or other pointing device, scroll wheel, click wheel, dial, button, switch, keypad, microphone, and so on.

User output device 424 can include any device via which client computing system 414 can provide information to a user. For example, user output device 424 can include a display to display images generated by or delivered to client computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some implementations can include a device such as a touchscreen that function as both input and output device. In some implementations, other user output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 404 and 416 can provide various functionality for server system 400 and client computing system 414, including any of the functionality described herein as being performed by a server or client, or other functionality associated with message management services.

It will be appreciated that server system 400 and client computing system 414 are illustrative and that variations and modifications are possible. Computer systems used in connection with implementations of the present disclosure can have other capabilities not specifically described here. Further, while server system 400 and client computing system 414 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of these. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “client device”, “computing platform”, “computing device”, or “device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of these. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor can receive instructions and data from a read-only memory or a random access memory or both. The elements of a computer include a processor for performing actions in accordance with instructions and one or more memory devices for storing instructions and data. Generally, a computer can also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a player, implementations of the subject matter described in this specification can be implemented on a computer having a display device, e.g., a CRT (cathode ray tube), plasma, or LCD (liquid crystal display) monitor, for displaying information to the player and a keyboard and a pointing device, e.g., a mouse or a trackball, by which the player can provide input to the computer. Other kinds of devices can be used to provide for interaction with a player as well; for example, feedback provided to the player can include any form of sensory feedback, e.g., visual feedback, auditory feedback, or tactile feedback; and input from the player can be received in any form, including acoustic, speech, or tactile input. In addition, a computer can interact with a player by sending documents to and receiving documents from a device that is used by the player; for example, by sending web pages to a web browser on a player's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a player can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the gaming system described herein can include clients and servers. For example, the gaming system can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a player interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the gaming system could be a single module, a logic device having one or more processing modules, one or more servers, or part of a search engine.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, elements, or acts of the systems and methods herein referred to in the singular may also embrace implementations including a plurality of these elements; and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence has any limiting effect on the scope of any claim elements.

The systems and methods described herein may be embodied in other specific forms without departing from their characteristics thereof. The systems and methods described herein may be applied to other environments. The foregoing implementations are illustrative, rather than limiting, of the described systems and methods. The scope of the systems and methods described herein may thus be indicated by the appended claims, rather than the foregoing description, and changes that come within the meaning and range of equivalency of the claims are embraced therein.

What is claimed is:

1. A system, comprising:
one or more processors coupled to non-transitory memory, the one or more processors configured to:
maintain a plurality of wager opportunities corresponding to a plurality of live events, each of the plurality of wager opportunities identifying at least one of a plurality of teams or a plurality of participants of one or more live events;
maintain a dataset identifying one or more participant attributes of the plurality of participants and one or more team attributes of the plurality of teams;
receive, from a client device, a prompt comprising a request for a wager recommendation, the request identifying a requested attribute of a participant of the plurality of participants or a team of the plurality of teams;
generate, using a language model, the prompt, and at least a portion of the dataset, an output message identifying at least one wager opportunity of the plurality of wager opportunities selected based on the requested attribute; and
provide the output message to the client device in response to the request.

2. The system of claim 1, wherein the one or more team attributes comprise one or more of a ranking of each of the plurality of teams, a performance of a corresponding team of the plurality of teams in one or more live events, or a type of sport in which each of the plurality of teams participate.

3. The system of claim 1, wherein the one or more participant attributes comprise one or more of a ranking of each of the plurality of participants or subsets thereof, one or more performance metrics of each of the plurality of participants in one or more live events, or one or more associations with the plurality of teams.

4. The system of claim 1, wherein the one or more processors are further configured to:
determine that the request comprises an attribute request for wager opportunities corresponding to one or more top ranking players; and
select a subset of the plurality of wager opportunities that identify one or more participants of the plurality of participants that satisfy the attribute request.

5. The system of claim 4, wherein the one or more processors are further configured to:
generate an input context for the language model to include data of the subset of wager opportunities; and
generate the output message by providing the input context to the language model.

6. The system of claim 1, wherein the one or more processors are further configured to:
generate the output message to include a plurality of candidate wager opportunities selected from the plurality of wager opportunities, each candidate wager opportunity selected based on a similarity between the candidate wager opportunity and the at least one requested attribute.

7. The system of claim 6, wherein the one or more processors are further configured to:
receive, from the client device, a second prompt identifying a second requested attribute; and
generate, using the language model and the second prompt, a second output message comprising a first wager opportunity of the plurality of candidate wager opportunities, the first wager opportunity selected based on the second requested attribute.

8. The system of claim 1, wherein the dataset further comprises one or more historical participant attributes of one or more historical participants or one or more historical team attributes of one or more historical teams.

9. The system of claim 8, wherein the one or more processors are further configured to:
receive, from a client device, a second prompt comprising a second request for a wager recommendation, the second request identifying a historical attribute of the plurality of historical participants that relates to one or more of the plurality of participants; and
generate, using the language model, the second prompt, and data of the plurality of wager opportunities, an output message identifying at least one second wager opportunity of the plurality of wager opportunities selected based on the historical attribute.

10. The system of claim 1, wherein the client device is associated with a player profile, and wherein the one or more processors are further configured to:
generate the output message further based on the player profile.

11. A method, comprising:
maintaining, by one or more processors coupled to non-transitory memory, a plurality of wager opportunities corresponding to a plurality of live events, each of the plurality of wager opportunities identifying at least one of a plurality of teams or a plurality of participants of one or more live events;
maintaining, by the one or more processors, a dataset identifying one or more participant attributes of the plurality of participants and one or more team attributes of the plurality of teams;
receiving, by the one or more processors, from a client device, a prompt comprising a request for a wager recommendation, the request identifying a requested attribute of a participant of the plurality of participants or a team of the plurality of teams;
generating, by the one or more processors, using a language model, the prompt, and at least a portion of the dataset, an output message identifying at least one wager opportunity of the plurality of wager opportunities selected based on the requested attribute; and
providing, by the one or more processors, the output message to the client device in response to the request.

12. The method of claim 11, wherein the one or more team attributes comprise one or more of a ranking of each of the plurality of teams, a performance of a corresponding team of the plurality of teams in one or more live events, or a type of sport in which each of the plurality of teams participate.

13. The method of claim 11, wherein the one or more participant attributes comprise one or more of a ranking of each of the plurality of participants or subsets thereof, one or more performance metrics of each of the plurality of participants in one or more live events, or one or more associations with the plurality of teams.

14. The method of claim 11, further comprising:
determining, by the one or more processors, that the request comprises an attribute request for wager opportunities corresponding to one or more top ranking players; and
selecting, by the one or more processors, a subset of the plurality of wager opportunities that identify one or more participants of the plurality of participants that satisfy the attribute request.

15. The method of claim 14, further comprising:
generating, by the one or more processors, an input context for the language model to include data of the subset of wager opportunities; and
generating, by the one or more processors, the output message by providing the input context to the language model.

16. The method of claim 11, further comprising:
generating, by the one or more processors, the output message to include a plurality of candidate wager opportunities selected from the plurality of wager opportunities, each candidate wager opportunity selected based on a similarity between the candidate wager opportunity and the at least one requested attribute.

17. The method of claim 16, wherein the one or more processors are further configured to:
receiving, by the one or more processor, from the client device, a second prompt identifying a second requested attribute; and
generating, by the one or more processors, using the language model and the second prompt, a second output message comprising a first wager opportunity of the plurality of candidate wager opportunities, the first wager opportunity selected based on the second requested attribute.

18. The method of claim 11, wherein the dataset further comprises one or more historical participant attributes of one or more historical participants or one or more historical team attributes of one or more historical teams.

19. The method of claim 8, further comprising:
receiving, by the one or more processor, from a client device, a second prompt comprising a second request for a wager recommendation, the second request identifying a historical attribute of the plurality of historical participants that relates to one or more of the plurality of participants; and
generating, by the one or more processors, using the language model, the second prompt, and data of the plurality of wager opportunities, an output message identifying at least one second wager opportunity of the plurality of wager opportunities selected based on the historical attribute.

20. The method of claim 11, wherein the client device is associated with a player profile, and further comprising:
generating, by the one or more processors, the output message further based on the player profile.
